(19) United States
(12) Patent Application Publication
(10) Pub. No.: US 2025/0038678 A1
(43) Pub. Date: Jan. 30, 2025

(54) Power Control Method And Device For Minimizing Frequency Variation Of Full-Bridge Induction Heating Inverter

(71) Applicants: UNIST (ULSAN NATIONAL INSTITUTE OF SCIENCE AND TECHNOLOGY), Ulsan (KR); SHINSUNG DELTA IND. CO., LTD, Gyeongsangnam-do (KR)

(72) Inventors: Jee Hoon JUNG, Ulsan (KR); Wonsik JEONG, Ulsan (KR); Junsuk LEE, Ulsan (KR); Jisoo KIM, Gyeongsangnam-do (KR); Byung Jo JEONG, Gyeongsangnam-do (KR)

(73) Assignees: UNIST (ULSAN NATIONAL INSTITUTE OF SCIENCE AND TECHNOLOGY), Ulsan (KR); SHINSUNG DELTA IND. CO., LTD, Gyeongsangnam-do (KR)

(21) Appl. No.: 18/783,233

(22) Filed: Jul. 24, 2024

(30) Foreign Application Priority Data
Jul. 25, 2023 (KR) 10-2023-0096837

(51) Int. Cl. H02M 7/5387; H02M 7/48; H05B 6/06

(52) U.S. Cl. CPC H02M 7/53871; H02M 7/4815; H05B 6/06

(57) ABSTRACT

A power control method and device for minimizing frequency variation of a full-bridge induction heating inverter are provided. The power control method includes, as a switching frequency for operating the full-bridge induction heating inverter increases, defining a section of output power that is output from the full-bridge induction heating inverter to include at least a mid-power section and a low-power section and in the mid-power section and the low-power section, limiting a variation range of the switching frequency by controlling power of a switch in the full-bridge induction heating inverter using phase shift modulation (PSM).

### CROSS-REFERENCE TO RELATED APPLICATION

This application claims the benefit of Korean Patent Application No. 10-2023-0096837, filed on Jul. 25, 2023, in the Korean Intellectual Property Office, the entire disclosure of which is incorporated herein by reference for all purposes.

### BACKGROUND

### 1. Field of the Invention

One or more embodiments relate to the field of induction heating based on power electronics technology.

Induction heating is widely used in homes and industries due to advantages of fast heating speed, eco-friendliness of not using fossil fuels, and high efficiency due to direct heating.

The present disclosure relates to power control technology of induction heating using a full-bridge series resonance topology together with pulse frequency modulation (PFM), phase shift modulation (PSM), and pulse density modulation (PDM).

### 2. Description of the Related Art

JP 6782429 (2020 Oct. 22), “Single-stage commercial frequency-high frequency converter for induction heating and method of controlling the same”

JP 6782429 discloses a single-stage commercial frequency-high frequency converter for induction heating that allows direct power conversion in a single-stage circuit configuration from an input single-phase commercial frequency alternating current power source to a high-frequency output and is suitable for high-output applications.

Application No. 10-1480984 (2015 Jan. 5), “Induction heating method implemented in device including magnetically coupled inductor”

Application No. 10-1480984 discloses an induction heating method implemented in a device including a magnetically coupled inductor to heat a metal portion such as a sheet or a bar.

Application No. 20-0243877 (2001 Aug. 9), “Two-stage switching power conversion device”

Application No. 20-0243877 discloses a time-varying frequency tracking phase shift control circuit for controlling a phase shift and tracking a temporally changing frequency using triangle waves generated at both ends of an oscillation capacitor connected to a phase-locked loop (PLL) circuit.

FIG. 1 is a diagram illustrating an existing full-bridge series resonance inverter.

In FIG. 1, the existing full-bridge series resonance inverter is illustrated.

The existing full-bridge series resonance inverter may include a circuit in which switches S1 to S4 are arranged in a full bridge form as shown in FIG. 1, and the switches S1 to S4 may be switched according to a switching frequency based on pulse frequency modulation (PFM) to output power for induction heating.

FIG. 2 is a diagram illustrating a graph of output power versus a switching frequency in an existing full-bridge series resonance inverter.

An existing control method of induction heating may use PFM to operate a full-bridge series resonance inverter and may be performed such that the output power increases when the switching frequency, which is an operating frequency, is close to a resonant frequency and the output power decreases when the switching frequency is far from the resonant frequency.

As shown in FIG. 2, when the resonant frequency is 2.8*10⁴ hertz (Hz), in the existing control method of induction heating, a section where the switching frequency is higher than the resonant frequency 2.8*10⁴ Hz may be divided into high-power, mid-power, and low-power sections, and in the high-power, mid-power, and low-power sections, the full-bridge series resonance inverter may be operated.

However, in the existing control method of induction heating, the full-bridge series resonance inverter is operated using only the PFM. Accordingly, there is a disadvantage that, in the mid-to-low power sections, the increase in the switching frequency is significant compared to the decrease in the output power so that the switching frequency becomes too high when driving at low power.

In the existing control method of induction heating, the full-bridge series resonance inverter may be operated using the PFM. In addition, in the existing control method of induction heating, induction heating may be performed by converting to pulse density modulation (PDM) for the output power in the low-power section.

Here, the low-power section operated by the PDM may generate noise due to repetitive on and off.

In addition, since the low-power section is operated at a high switching frequency, which is a characteristic of the full-bridge series resonance inverter described above, switching loss may significantly increase.

Therefore, there is an urgent need for an improved control method of induction heating that minimizes frequency variation of a switching frequency.

### SUMMARY

Embodiments are to provide a power control method and device for minimizing frequency variation of a full-bridge induction heating inverter that provides a difference in switching for each power section in order to minimize a frequency variation range.

In addition, embodiments are to reduce a frequency band in which switching loss and noise occur by reducing a switching frequency when operating in a low-power section.

According to an aspect, there is provided a power control method of minimizing frequency variation of a full-bridge induction heating inverter, the power control method including, as a switching frequency for operating the full-bridge induction heating inverter increases, defining a section of output power that is output from the full-bridge induction heating inverter to include at least a mid-power section and a low-power section and in the mid-power section and the low-power section, limiting a variation range of the switching frequency by controlling power of a switch in the full-bridge induction heating inverter using phase shift modulation (PSM).

According to another aspect, there is provided a power control device of minimizing frequency variation of a full-bridge induction heating inverter, the power control device including a definition unit configured to, as a switching frequency for operating the full-bridge induction heating inverter increases, define a section of output power that is output from the full-bridge induction heating inverter to include at least a mid-power section and a low-power section and a processor configured to, in the mid-power section and the low-power section, limit a variation range of the switching frequency by controlling power of a switch in the full-bridge induction heating inverter using PSM.

Additional aspects of embodiments will be set forth in part in the description which follows and, in part, will be apparent from the description, or may be learned by practice of the disclosure.

According to embodiments, a power control method and device for minimizing frequency variation of a full-bridge induction heating inverter that provides a difference in switching for each power section in order to minimize a frequency variation range may be provided.

In addition, according to embodiments, by dividing a power section and using different modulation techniques, variation of an operating frequency in mid-to-low power sections may be minimized, interference noise of a multiplexer may be eliminated within the range that a switching element may manage, and high-frequency switching loss may be reduced, thereby allowing operation with high efficiency.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an existing full-bridge series resonance inverter;

FIG. 2 is a diagram illustrating a graph of output power versus a switching frequency in an existing full-bridge series resonance inverter;

FIG. 3 is a block diagram illustrating a configuration of a power control device for minimizing frequency variation of a full-bridge induction heating inverter, according to an embodiment;

FIG. 4 is a diagram illustrating an equivalent circuit of a full-bridge series resonance inverter;

FIG. 5A and FIG. 5B is a diagram illustrating a switching operation of a full-bridge series resonance inverter;

FIG. 6A and FIG. 6B is a diagram illustrating an operation mode, an output voltage, and a current waveform according to phase shift modulation (PSM);

FIG. 7 is a diagram illustrating operation characteristics of each power section in an STS-430 container;

FIG. 8 is a diagram illustrating operation characteristics of each power section in an STS-304 container;

FIG. 9 is a diagram illustrating an output voltage waveform of existing pulse density modulation (PDM);

FIG. 10 is a diagram illustrating an output voltage waveform of improved PDM; and

FIG. 11 is a flowchart illustrating a power control method of minimizing frequency variation of a full-bridge induction heating inverter, according to an embodiment.

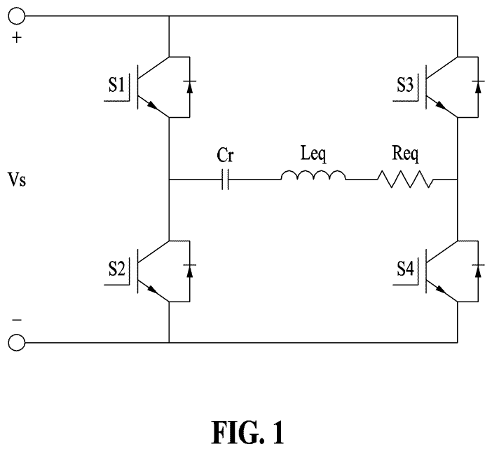

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

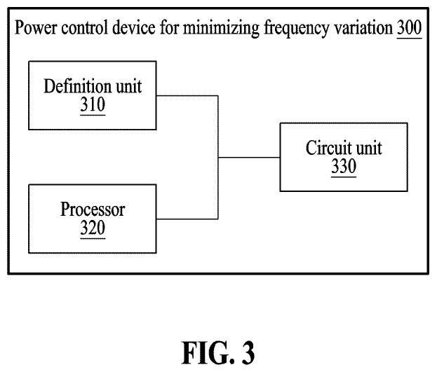

FIG. 3 is a block diagram illustrating a configuration of a power control device for minimizing frequency variation of a full-bridge induction heating inverter, according to an embodiment.

Referring to FIG. 3, a power control device for minimizing frequency variation of a full-bridge induction heating inverter 300 (hereinafter abbreviated as “a power control device for minimizing frequency variation”) according to an embodiment of the present disclosure may be configured to include a definition unit 310 and a processor 320. In addition, depending on embodiments, the power control device for minimizing frequency variation 300 may be configured by selectively adding a circuit unit 330.

First, the definition unit 310 may define, as a switching frequency for operating the full-bridge induction heating inverter increases, a section of output power that is output from the full-bridge induction heating inverter to include at least a mid-power section and a low-power section. That is, the definition unit 310 may define, for each section, the size of the output power output from the full-bridge induction heating inverter according to the size of the switching frequency.

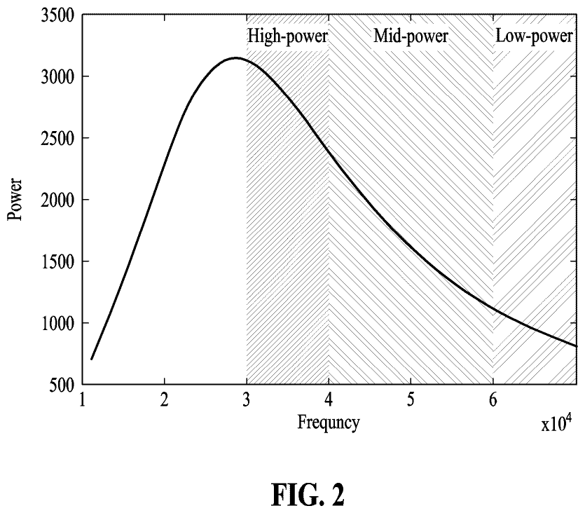

For example, as shown in FIG. 2, in operating a full-bridge series resonance inverter using pulse frequency modulation (PFM), as the switching frequency moves away with higher frequency than a resonant frequency, the definition unit 310 may define a high-power section, a mid-power section, and a low-power section for each section, for decreasing output power.

That is, as a switch in the full-bridge induction heating inverter is power-controlled using PFM and the switching frequency increases, the definition unit 310 may define the section of the output power as the high-power section, when the increasing switching frequency is greater than or equal to the resonant frequency of the full-bridge induction heating inverter and less than a set first frequency.

In addition, the definition unit 310 may define the section of the output power as the mid-power section when the increasing switching frequency is greater than or equal to the first frequency and less than a set second size.

In addition, the definition unit 310 may define the section of the output power as the low-power section when the increasing switching frequency is greater than or equal to the second frequency.

Here, the first frequency may be set to be greater than the resonant frequency and less than the second frequency.

Referring to FIG. 2, the definition unit 310 may define the section 2400 to 3200 Watt (W) of the output power as the high-power section when the resonant frequency is 2.8*10⁴ hertz (Hz) or higher and the set first frequency is less than 4.0*10⁴ Hz.

In addition, the definition unit 310 may define the section 1200 to 2400 W of the output power as the mid-power section when the first frequency is 4.0*10⁴ Hz or higher and the set second size is less than 6.0*10⁴ Hz.

In addition, the definition unit 310 may define the section to 1200 W of the output power as the low-power section when the second frequency is 6.0*10⁴ Hz or higher.

In the mid-power section and the low-power section, the processor 320 may limit a variation range of the switching frequency by controlling power of the switch in the full-bridge induction heating inverter using phase shift modulation (PSM). That is, the processor 320 may control the power of the switch using PSM so that the output power from the full-bridge induction heating inverter is greatly reduced even with a small increase in a low switching frequency.

In other words, in the mid-power section and the low-power section, the processor 320 may limit the variation range of the switching frequency by making a range of increasing the switching frequency when controlling power using PSM relatively smaller than a range of increasing the switching frequency when controlling power using PFM, in order to output regulated power.

Referring to FIG. 2, the processor 320 may control the power of the switch in the full-bridge induction heating inverter using PSM, thereby generating a waveform steeper downward than the waveform of FIG. 2 (a PFM technique) in the mid-power section and the low-power section.

Accordingly, the processor 320 may limit the variation range of the switching frequency by reducing the amount of increase in the switching frequency and increasing the amount of decrease in the output power.

The full-bridge induction heating inverter may include four switches S1 to S4.

In order to configure a circuit of these four switches S1 to S4, the circuit unit 330 may be selectively added to the power control device for minimizing frequency variation 300.

The circuit unit 330 may include switches S1 and S2 arranged in series at one end of a circuit of the full-bridge induction heating inverter and switches S3 and S4 arranged in series at the other end of the circuit and may connect the switches S1 and S2 and the switches S3 and S4 in parallel. That is, the circuit unit 330 may configure a circuit for the full-bridge induction heating inverter by connecting the switches S1 and S2 and the switches S3 and S4 in parallel.

Subsequently, by adjusting a phase difference ϕ between Leg1 including the switches S1 and S2 and Leg2 including the switches S3 and S4, the processor 320 may determine a plurality of modes for power control using the PSM.

The processor 320 may determine modes 1 to 6 according to the number of cases in which on and off states of the switches S1 and S2 in Leg1 are combined with on and off states of the switches S3 and S4 in Leg2.

Specifically, by controlling the switch S1 of Leg1 and the switch S4 of Leg2 to be on, the processor 320 may determine mode 1 in which output voltage Vo is positive and output current Io increases at an anode (+).

By controlling the switches S1 and S2 of Leg1 to be off and the switch S4 of Leg2 to be on, the processor 320 may determine mode 2 in which the output voltage Vo is 0 and the output current Io decreases at the anode (+).

By controlling the switch S4 of Leg2 to be off and the switch S2 of Leg1 and the switch S3 of Leg2 to be on, the processor 320 may determine mode 3 in which the output voltage Vo is negative and the output current Io converges to 0.

By controlling the switch S2 of Leg1 and the switch S3 of Leg2 to be on, the processor 320 may determine mode 4 in which the output voltage Vo is negative and the output current Io increases at a cathode (−).

By controlling the switch S2 of Leg1 to be off and the switch S1 of Leg1 and the switch S3 of Leg2 to be on, the processor 320 may determine mode 5 in which the output voltage Vo is 0 and the output current Io decreases at the cathode (−).

By controlling the switch S3 of Leg2 to be off and the switch S1 of Leg1 and the switch S4 of Leg2 to be on, the processor 320 may determine mode 6 in which the output voltage Vo is positive and the output current Io converges to 0.

The situation in which the switch operates in the on state may be the same state as mode 1 and 4, and current may flow.

The switching situations such as modes 2, 3, 5, and 6 may be an operation in which current flows through a diode connected to a switching device in parallel when the voltage of the switching device is discharged.

In addition, in the switching situations such as modes 2 and 5, zero voltage switching may occur in which the output voltage becomes 0 and here, although the voltage is 0, current flows to a load so that power may be supplied to the load.

Modes 2 and 5 may have the output voltage Vo 0.

Due to the output voltage Vo being 0 by mode 2 and mode 5, the processor 320 may output the output voltage lower than when operating the full-bridge induction heating inverter with the switching frequency of the same size in PFM to limit the variation range of the switching frequency.

That is, through the zero voltage output, the processor 320 may output the output power lower than when operating the full-bridge induction heating inverter using PFM for the switching frequency of the same size.

According to an embodiment, the power control device for minimizing frequency variation 300 may alleviate noise and may lower the output power to the maximum through improved pulse density modulation (PDM) that adjusts a timing ratio for a switching waveform at the beginning and the end of the PDM.

In the low-power section, by adjusting a switching interval of the switching frequency using the PDM, the processor 320 may minimize frequency variation of the full-bridge induction heating inverter and may reduce noise and vibration.

That is, by varying the size of a phase shift angle ϕ1 at the beginning and the end of a section of switching in a PDM cycle and the size of a phase shift angle ϕ2 in the middle of the section, the processor 320 may maintain the output power and may reduce noise and vibration.

For example, the processor 320 may reduce noise and vibration by making the phase shift angle ϕ1 at the beginning and the end of the low-power section greater than the phase shift angle ϕ2 in the middle of the low-power section so that the switching continues during the PDM cycle in the low-power section.

The processor 320 may flexibly adjust a maintenance period of modes 2 and 5, in which zero voltage occurs, to reduce noise and vibration in the low-power section.

According to embodiments, a power control method and device for minimizing frequency variation of a full-bridge induction heating inverter that provides a difference in switching for each power section in order to minimize a frequency variation range may be provided.

In addition, according to embodiments, by dividing a power section and using different modulation techniques, variation of an operating frequency in mid-to-low power sections may be minimized, interference noise of a multiplexer may be eliminated within the range that a switching element may manage, and high-frequency switching loss may be reduced, thereby allowing operation with high efficiency.

In order to overcome disadvantages of existing induction heating control, the power control device for minimizing frequency variation 300 of the present disclosure may operate in the mid-to-low power sections using the PSM.

Here, the mid-to-low power sections may be sections in which the switching frequency moves away with a frequency higher than the resonance frequency. Referring to FIG. 2 above, the mid-to-low power sections may refer to power sections in which power is output at about 2400 W or less.

For example, in the case of a home induction heating system, the power section may include 0 to 9 stages (stage 1: 100, stage 2: 200, stage 3: 400, . . . stage 9: 2000) and the power control device for minimizing frequency variation 300 may define the power section of stages 1 to 7 as the mid-to-low power sections.

The power control device for minimizing frequency variation 300 may divide the output power of the full-bridge series resonance inverter into high, medium, and low power sections as shown in FIG. 2 and may operate the full-bridge series resonance inverter in the mid-to-low power sections using the PSM, thereby minimizing the frequency variation range.

The power control device for minimizing frequency variation 300 may operate the full-bridge series resonance inverter in the high-power section using the PFM.

In addition, the power control device for minimizing frequency variation 300 may improve the existing PDM in the low-power section to continuously generate and output the output power for a predetermined period.

The power control device for minimizing frequency variation 300 may operate the full-bridge series resonance inverter in the mid-to-low power sections using the PSM, and thus, a 0 voltage may be generated by the phase difference ϕ between the switches S1 and S4 and the switches S2 and S3. Accordingly, compared to the existing PFM, lower output power may be output using the same switching frequency. Through this, the power control device for minimizing frequency variation 300 may generate low output power due to the phase difference between the switches, even in a state where the frequency variation range of the switching frequency is reduced.

The power control device for minimizing frequency variation 300 may alleviate noise and may lower the output power to the maximum through improved PDM that adjusts the phase difference for a switching waveform at the beginning and the end of the PDM in the low-power section.

The power control device for minimizing frequency variation 300 may operate the full-bridge series resonance inverter while minimizing the frequency variation by controlling induction heating in different methods for each power section.

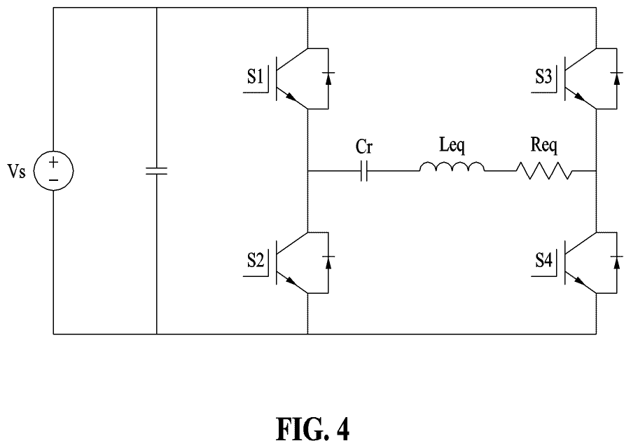

FIG. 4 is a diagram illustrating an equivalent circuit of a full-bridge series resonance inverter.

An induction heater may include a resonance circuit as shown in FIG. 4, and this resonance circuit may be referred to as a resonance tank.

Leq and Req may respectively represent an equivalent inductance and an equivalent resistance of a coil.

In the graph of FIG. 2, the frequency at which a voltage gain is 1 is the resonant frequency and a general induction heater may be operated by setting a switching frequency to be greater than a resonant frequency.

Therefore, for the induction heater, as the switching frequency increases, voltage gain may decrease and output power may decrease.

In addition, when the induction heater drives a full-bridge series resonance inverter at a high switching frequency, there may occur an issue that loss increases and efficiency decreases.

In order to overcome this issue, the power control device for minimizing frequency variation 300 of the present disclosure may use PFM in a high-power section and PSM in mid-to-low power sections, and thus, the full-bridge series resonance inverter may be operated at a relatively low switching frequency in the mid-to-low power sections.

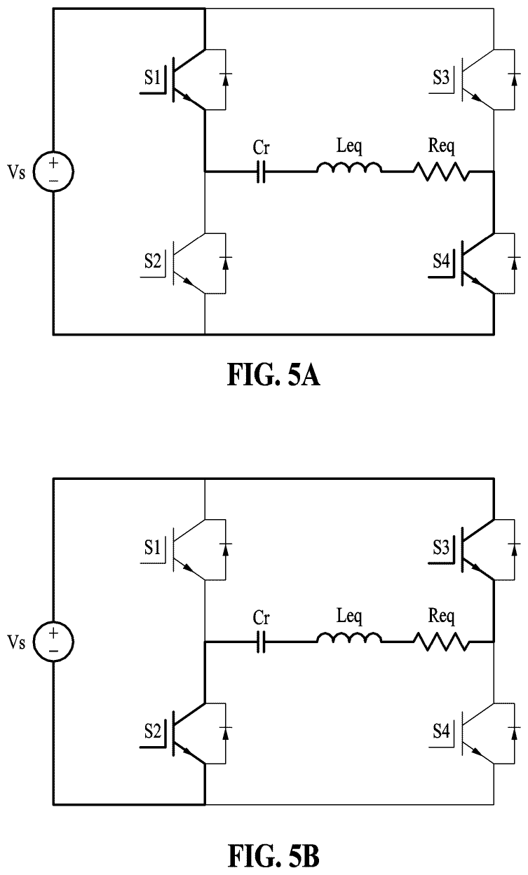

FIG. 5A and FIG. 5B is a diagram illustrating a switching operation of a full-bridge series resonance inverter.

The power control device for minimizing frequency variation 300 may independently control power by dividing switches in a full-bridge series resonance inverter into Leg1 (the switches S1 and S2) and Leg2 (the switches S3 and S4).

As shown in FIG. 5A, when the phase difference between Leg1 and Leg2 is switched to 0.5, the power control device for minimizing frequency variation 300 may control the switch S1 of Leg1 to be on and the switch S4 of Leg2, which is bridge-connected by Cr, Leq, and Req, to be on to modulate the frequency and transmit power (the switches S2 and S3 are controlled to be off).

Similarly, referring to FIG. 5B, the power control device for minimizing frequency variation 300 may control the switch S2 of Leg1 to be on and the switch S3 of Leg2, which is bridge-connected by Cr, Leq, and Req, to be on to modulate the frequency and transmit power (the switches S1 and S4 are controlled to be off).

Here, Cr represents a resonance capacitor and Leq and Req respectively represent an equivalent inductance and an equivalent resistance of a coil.

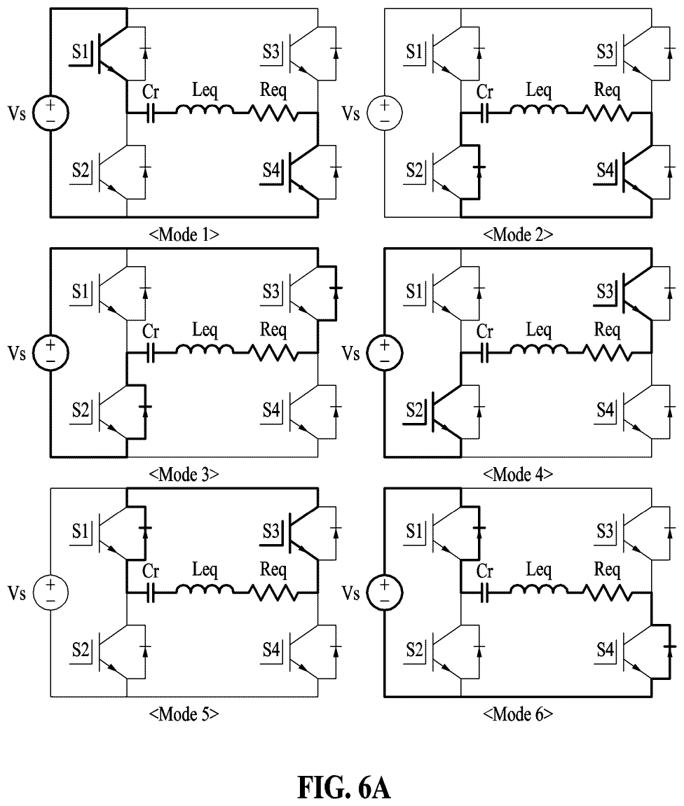

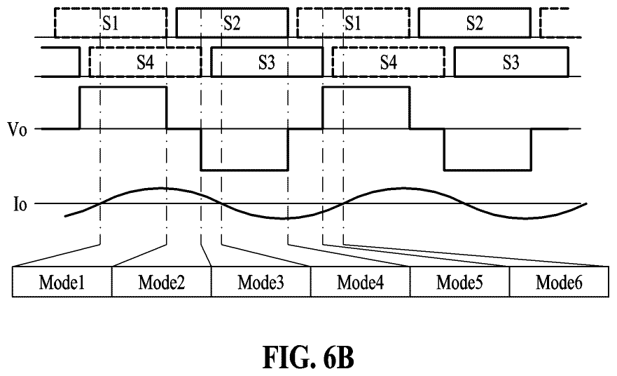

The power control device for minimizing frequency variation 300 may have a switching mode as shown in FIG. 6A and FIG. 6B and may obtain an output voltage and a current waveform by operating the full-bridge series resonance inverter in mid-to-low power sections using PSM.

FIG. 6A and FIG. 6B is a diagram illustrating an operation mode, an output voltage, and a current waveform according to PSM.

As shown in FIG. 6A and FIG. 6B, the power control device for minimizing frequency variation 300 may perform switching by appropriately adjusting the phase difference between Leg1 and Leg2 (e.g., 0.4) and thus, modes 1 to 6 according to on and off states of the switches S1 to S4 may be determined.

The power control device for minimizing frequency variation 300 may determine the case, to be mode 1, in which the switch S1 of Leg1 and the switch S4 of Leg2 are controlled to be on. Here, output voltage Vo is positive and output current Io increases at an anode (+).

The power control device for minimizing frequency variation 300 may determine the case, to be mode 2, in which the switches S1 and S2 of Leg1 are controlled to be off and the switch S4 of Leg2 is controlled to be on. Here, the output voltage Vo is 0 and the output current Io decreases at the anode (+).

The power control device for minimizing frequency variation 300 may determine the case, to be mode 3, in which the switch S4 of Leg2 is controlled to be off and the switch S2 of Leg1 and the switch S3 of Leg2 are controlled to be on. Here, the output voltage Vo is negative and the output current Io converges to 0.

The power control device for minimizing frequency variation 300 may determine the case, to be mode 4, in which the switch S2 of Leg1 and the switch S3 of Leg2 are controlled to be on. Here, the output voltage Vo is negative and the output current Io increases at a cathode (−).

The power control device for minimizing frequency variation 300 may determine the case, to be mode 5, in which the switch S2 of Leg1 is controlled to be off and the switch S1 of Leg1 and the switch S3 of Leg2 are controlled to be on. Here, the output voltage Vo is 0 and the output current Io decreases at the cathode (−).

The power control device for minimizing frequency variation 300 may determine the case, to be mode 6, in which the switch S3 of Leg2 is controlled to be off and the switch S1 of Leg1 and the switch S4 of Leg2 are controlled to be on. Here, the output voltage Vo is positive and the output current Io converges to 0.

The power control device for minimizing frequency variation 300 may generate a zero voltage as an output voltage in modes 2 and 5 by operating a full-bridge series resonance inverter using PSM. Due to this zero voltage, the power control device for minimizing frequency variation 300 may obtain lower output power than when operating at the same frequency as the existing PFM.

Accordingly, the power control device for minimizing frequency variation 300 may minimize a frequency variation range in mid-to-low power sections using PSM.

The output power when operating the full-bridge series resonance inverter using the PSM may be calculated based on Equation 1.

$$\begin{matrix}[ Equation 1 ] & \\ {ϕ}_{max} = 2 ( α - {β}_{min} ) & ( 1 )\end{matrix}$$

$$α = {tan}^{- 1} [ Q ( \frac{{ω}_{s}}{{ω}_{r}} - \frac{{ω}_{r}}{{ω}_{s}} ) ] \qquad ( 2 )$$

$${β}_{min} = {cos}^{- 1} ( 1 - \frac{2 {ω}_{s} {q}_{Coss}}{{I}_{m}} ) \qquad ( 3 )$$

$${P}_{Transfer} = {R}_{eq} \frac{\frac{2 \sqrt{2 A}}{π} {V}_{rect} \times sin ( π A )}{\sqrt{{R}_{eq} + {( ω {L}_{eq} - \frac{1}{ω {C}_{r}} )}^{2}}} ( A = D - ( \frac{ϕ°}{360 °} ) ) \qquad ( 4 )$$

ϕ: phase shift angle ωₛ: switching angular frequency
ωᵣ: resonance angular frequency q_{Coss}: electric charge of output capacitor of switch
Iₘ: maximum value of output current α: phase angle of resonance current
β: phase difference between output voltage and current P_{Transfer}: output power
V_{rect}: resonant tank input voltage

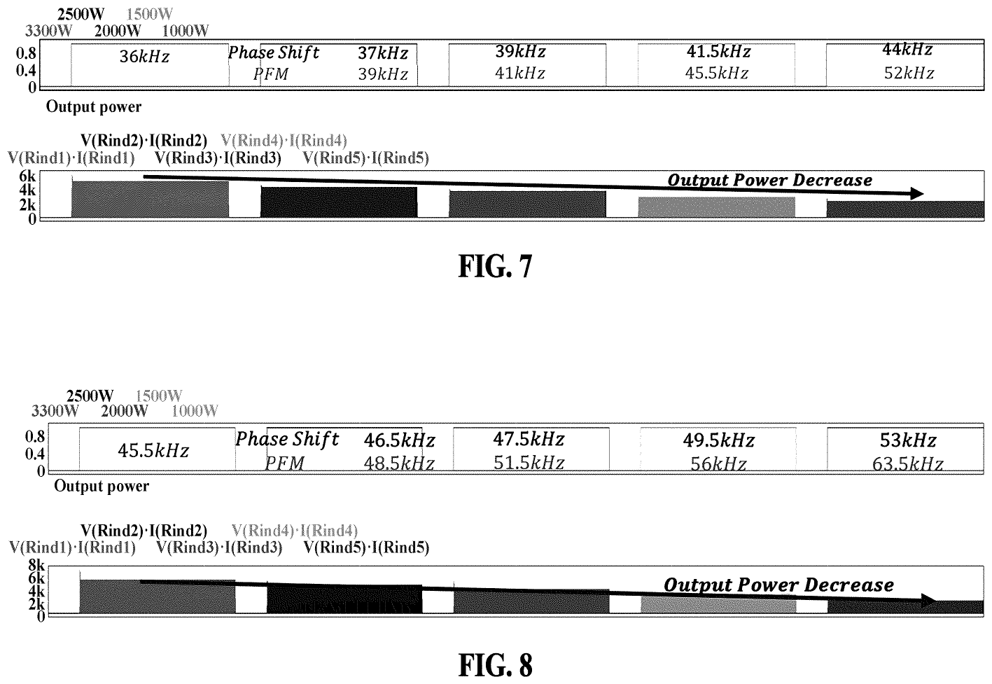

FIG. 7 is a diagram illustrating operation characteristics of each power section in an STS-430 container.

FIG. 7 shows the difference in a switching frequency for each power section in the STS-430 container.

When a full-bridge induction heating inverter is operated at a switching frequency of 36 kilohertz (kHz), which is a resonant frequency, output power is 3.3 kilowatt (KW).

When the switching frequency is raised using only PFM, a switching frequency of 52 kHz is required for switching in a 1 KW section, which is included in mid-to-low power sections.

However, the power control device for minimizing frequency variation 300 according to the present disclosure may switch at a switching frequency of 44 kHz in a 1 KW section, which is included in the mid-to-low power sections, using PSM.

As described above, the power control device for minimizing frequency variation 300 may use PSM in the mid-to-low power sections rather than only the existing PFM, so that the switching frequency may be lowered even when transmitting low power.

FIG. 8 is a diagram illustrating operation characteristics of each power section in an STS-304 container.

FIG. 8 shows the characteristics of the STS-304 container, which is one of the representative induction heating-only containers, for each power section.

The STS-304 container has a difference in resistance from the STS-430 container, and thus, the frequency when transmitting maximum power is high at 45.4 KHz.

Accordingly, for the STS-304 container, as described with reference to FIG. 7, heating using the PSM rather than heating using only the PFM may be effective in lowering the switching frequency and increasing power efficiency.

For 1 kW output using the STS-304 container, a switching frequency of 63.5 kHz is required when using only the PFM, but when using the PSM together, only the switching frequency of 53 kHz may be required, which has a difference of more than 10 KHz.

The power control device for minimizing frequency variation 300 may operate a full-bridge induction heating inverter without noise and vibration in mid-to-low power sections using improved PDM.

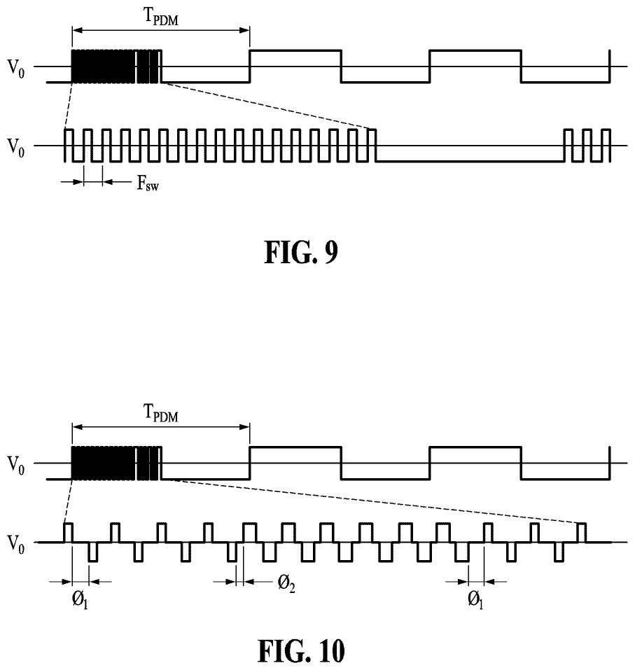

FIG. 9 is a diagram illustrating an output voltage waveform of existing PDM.

Typical PDM performs switching for a predetermined period and does not perform switching for the remaining periods.

Accordingly, as shown in FIG. 9, when an induction heater is operated using PDM, the size of output power may be determined according to PDM.

However, when power control is performed using the PDM, noise and vibration may occur since the amount of change in current between the time of starting and end of the switching is large.

When power control is performed on a home induction heater using the PDM, there may be a disadvantage that a user may be inconvenienced due to noise and vibration.

Therefore, the power control device for minimizing frequency variation 300 of the present disclosure may use improved PDM that may suppress noise and vibration in a low-power section.

FIG. 10 is a diagram illustrating an output voltage waveform of improved PDM.

As shown in FIG. 10, in the improved PDM, a switching interval may be adjusted to minimize frequency variation of an induction heater and may operate the induction heater without noise and vibration in a low-power section.

The power control device for minimizing frequency variation 300 may be operated by varying the size of the phase shift angle ϕ1 at the beginning and the end of a section of switching in a PDM cycle and the size of the phase shift angle ϕ2 in the middle. In other words, the power control device for minimizing frequency variation 300 may reduce the size of ϕ during PDM operation to obtain intended output power and may maximize the size of ϕ at the beginning and the end of PDM to reduce noise and vibration, thereby changing the size of ϕ linearly.

The power control device for minimizing frequency variation 300 may minimize frequency variation while obtaining output power desired by a user, by varying the switching for each power section in the induction heater.

The power control device for minimizing frequency variation 300 may reduce the burden on switches and may also reduce switching loss in the case of an induction heater using multiple burners.

The power control device for minimizing frequency variation 300 may reduce switching loss and noise frequency bandwidth by reducing the switching frequency in the low-power section by varying the modulation method in the induction heater.

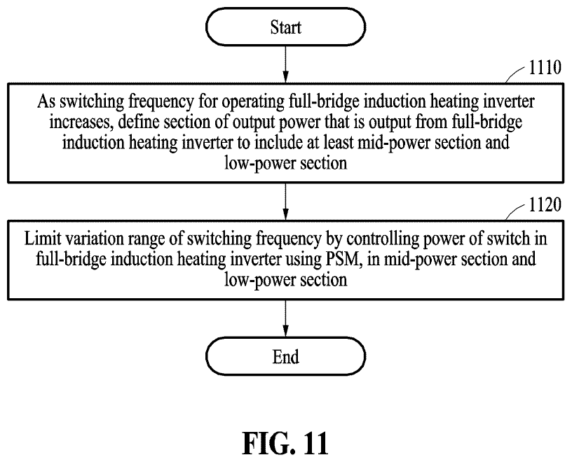

Hereinafter, a workflow of the power control device for minimizing frequency variation 300 according to embodiments of the present disclosure is described in detail with reference to FIG. 11.

FIG. 11 is a flowchart illustrating a power control method of minimizing frequency variation of a full-bridge induction heating inverter, according to an embodiment.

A power control method of minimizing frequency variation of a full-bridge induction heating inverter according to the embodiment may be performed by the power control device for minimizing frequency variation 300.

First, in operation 1110, the power control device for minimizing frequency variation 300 may define, as a switching frequency for operating the full-bridge induction heating inverter increases, a section of output power that is output from the full-bridge induction heating inverter to include at least a mid-power section and a low-power section. Operation 1110 may be a process of defining, for each section, the size of the output power output from the full-bridge induction heating inverter according to the size of the switching frequency.

For example, as shown in FIG. 2, in operating a full-bridge series resonance inverter using PFM, as the switching frequency moves away with higher frequency than the resonant frequency, the power control device for minimizing frequency variation 300 may define a high-power section, a mid-power section, and a low-power section for each section, for decreasing output power.

That is, as a switch in the full-bridge induction heating inverter is power-controlled using PFM and the switching frequency increases, the power control device for minimizing frequency variation 300 may define the section of the output power as the high-power section, when the increasing switching frequency is greater than or equal to the resonant frequency of the full-bridge induction heating inverter and less than a set first frequency.

In addition, the power control device for minimizing frequency variation 300 may define the section of the output power as the mid-power section when the increasing switching frequency is greater than or equal to the first frequency and less than a set second size.

In addition, the power control device for minimizing frequency variation 300 may define the section of the output power as the low-power section when the increasing switching frequency is greater than or equal to the second frequency.

Here, the first frequency may be set to be greater than the resonant frequency and less than the second frequency.

Referring to FIG. 2, the power control device for minimizing frequency variation 300 may define the section 2400 to 3200 W of the output power as the high-power section when the resonant frequency is 2.8*10⁴ Hz or higher and the set first frequency is less than 4.0*10⁴ Hz.

In addition, the power control device for minimizing frequency variation 300 may define the section 1200 to 2400 W of the output power as the mid-power section when the first frequency is 4.0*10⁴ Hz or higher and the set second size is less than 6.0*10⁴ Hz.

In addition, the power control device for minimizing frequency variation 300 may define the section to 1200 W of the output power as the low-power section when the second frequency is 6.0*10⁴ Hz or higher.

In operation 1120, in the mid-power section and the low-power section, the power control device for minimizing frequency variation 300 may limit a variation range of the switching frequency by controlling power of the switch in the full-bridge induction heating inverter using PSM. Operation 1120 may be a process of controlling the power of the switch using PSM so that the output power from the full-bridge induction heating inverter is greatly reduced, even with a small increase in a low switching frequency.

In other words, in the mid-power section and the low-power section, the power control device for minimizing frequency variation 300 may limit the variation range of the switching frequency by making a range of increasing the switching frequency when controlling power using the PSM relatively smaller than a range of increasing the switching frequency when controlling power using PFM, in order to output regulated power.

Referring to FIG. 2, the power control device for minimizing frequency variation 300 may control the power of the switch in the full-bridge induction heating inverter using PSM, thereby generating a waveform steeper downward than the waveform of FIG. 2 (a PFM technique) in the mid-power section and the low-power section.

Accordingly, the power control device for minimizing frequency variation 300 may limit the variation range of the switching frequency by reducing the amount of increase in the switching frequency and increasing the amount of decrease in the output power.

The full-bridge induction heating inverter may include four switches S1 to S4.

In order to configure a circuit of these four switches S1 to S4, the power control device for minimizing frequency variation 300 may arrange switches S1 and S2 in series at one end of a circuit of the full-bridge induction heating inverter, may arrange switches S3 and S4 in series at the other end of the circuit, and may connect the switches S1 and S2 and the switches S3 and S4 in parallel. That is, the power control device for minimizing frequency variation 300 may configure a circuit for the full-bridge induction heating inverter by connecting the switches S1 and S2 and the switches S3 and S4 in parallel.

Subsequently, by adjusting a phase difference ϕ between Leg1 including the switches S1 and S2 and Leg2 including the switches S3 and S4, the power control device for minimizing frequency variation 300 may determine a plurality of modes for power control using the PSM.

The power control device for minimizing frequency variation 300 may determine modes 1 to 6 according to the number of cases in which on and off states of the switches S1 and S2 in Leg1 are combined with on and off states of the switches S3 and S4 in Leg2.

Specifically, by controlling the switch S1 of Leg1 and the switch S4 of Leg2 to be on, the power control device for minimizing frequency variation 300 may determine mode 1 in which output voltage Vo is positive and output current Io increases at an anode (+).

By controlling the switches S1 and S2 of Leg1 to be off and the switch S4 of Leg2 to be on, the power control device for minimizing frequency variation 300 may determine mode 2 in which the output voltage Vo is 0 and the output current Io decreases at the anode (+).

By controlling the switch S4 of Leg2 to be off and the switch S2 of Leg1 and the switch S3 of Leg2 to be on, the power control device for minimizing frequency variation 300 may determine mode 3 in which the output voltage Vo is negative and the output current Io converges to 0.

By controlling the switch S2 of Leg1 and the switch S3 of Leg2 to be on, the power control device for minimizing frequency variation 300 may determine mode 4 in which the output voltage Vo is negative and the output current Io increases at a cathode (−).

By controlling the switch S2 of Leg1 to be off and the switch S1 of Leg1 and the switch S3 of Leg2 to be on, the power control device for minimizing frequency variation 300 may determine mode 5 in which the output voltage Vo is 0 and the output current Io decreases at the cathode (−).

By controlling the switch S3 of Leg2 to be off and the switch S1 of Leg1 and the switch S4 of Leg2 to be on, the power control device for minimizing frequency variation 300 may determine mode 6 in which the output voltage Vo is positive and the output current Io converges to 0.

Modes 2 and 5 may have the output voltage Vo 0.

Due to the output voltage Vo being 0 by mode 2 and mode 5, the power control device for minimizing frequency variation 300 may output the output voltage lower than when operating the full-bridge induction heating inverter with the switching frequency of the same size in PFM to limit the variation range of the switching frequency.

That is, through the zero voltage output, the power control device for minimizing frequency variation 300 may output the output power lower than when operating the full-bridge induction heating inverter using the PFM for the switching frequency of the same size.

According to an embodiment, the power control device for minimizing frequency variation 300 may alleviate noise and may lower the output power to the maximum through improved PDM that adjusts a timing ratio for a switching waveform at the beginning and the end of the PDM.

In the low-power section, by adjusting a switching interval of the switching frequency using the PDM, the power control device for minimizing frequency variation 300 may minimize frequency variation of the full-bridge induction heating inverter and may reduce noise and vibration.

That is, by varying the size of a phase shift angle ϕ1 at the beginning and the end of a section of switching in a PDM cycle and the size of a phase shift angle ϕ2 in the middle of the section, the power control device for minimizing frequency variation 300 may maintain the output power and may reduce noise and vibration.

For example, the power control device for minimizing frequency variation 300 may reduce noise and vibration by making the phase shift angle ϕ1 at the beginning and the end of the low-power section greater than the phase shift angle ϕ2 in the middle of the low-power section so that the switching continues during the PDM cycle in the low-power section.

A processor may flexibly adjust a maintenance period of modes 2 and 5, in which zero voltage occurs, to reduce noise and vibration in the low-power section.

According to embodiments, a power control method and device for minimizing frequency variation of a full-bridge induction heating inverter that provides a difference in switching for each power section in order to minimize a frequency variation range may be provided.

In addition, according to embodiments, by dividing a power section and using different modulation techniques, variation of an operating frequency in mid-to-low power sections may be minimized, interference noise of a multiplexer may be eliminated within the range that a switching element may manage, and high-frequency switching loss may be reduced, thereby allowing operation with high efficiency.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs or digital video discs (DVDs); magneto-optical media such as optical discs; and hardware devices that are specially configured to store and perform program instructions, such as read-only memory (ROM), a random-access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A power control method of minimizing frequency variation of a full-bridge induction heating inverter, the power control method comprising:
as a switching frequency for operating the full-bridge induction heating inverter increases, defining a section of output power that is output from the full-bridge induction heating inverter to include at least a mid-power section and a low-power section; and
in the mid-power section and the low-power section, limiting a variation range of the switching frequency by controlling power of a switch in the full-bridge induction heating inverter using phase shift modulation (PSM).

2. The power control method of claim 1, wherein
the defining of the section of the output power comprises:
as the switch in the full-bridge induction heating inverter is power-controlled using pulse frequency modulation (PFM) and the switching frequency increases,
defining the section of the output power as a high-power section when the increasing switching frequency is greater than or equal to a resonant frequency of the full-bridge induction heating inverter and less than a set first frequency;
defining the section of the output power as the mid-power section when the increasing switching frequency is greater than or equal to the first frequency and less than a set second size; and
defining the section of the output power as the low-power section when the increasing switching frequency is greater than or equal to a second frequency.

3. The power control method of claim 1, wherein
the limiting of the variation range of the switching frequency comprises, in the mid-power section and the low-power section, limiting the variation range of the switching frequency by making a range of increasing the switching frequency when controlling power using the PSM relatively smaller than a range of increasing the switching frequency when controlling power using PFM, in order to output regulated power.

4. The power control method of claim 1, further comprising:
arranging switches S1 and S2 in series at one end of a circuit of the full-bridge induction heating inverter, arranging switches S3 and S4 in series at the other end of the circuit, and connecting the switches S1 and S2 and the switches S3 and S4 in parallel; and
by adjusting a phase difference between Leg1 including the switches S1 and S2 and Leg2 including the switches S3 and S4, determining a plurality of modes for power control using the PSM.

5. The power control method of claim 4, wherein
the determining of the plurality of modes comprises:
by controlling the switch S1 of Leg1 and the switch S4 of Leg2 to be on, determining mode 1 in which output voltage Vo is positive and output current Io increases at an anode (+);
by controlling the switches S1 and S2 of Leg1 to be off and the switch S4 of Leg2 to be on, determining mode 2 in which the output voltage Vo is 0 and the output current Io decreases at the anode (+);
by controlling the switch S4 of Leg2 to be off and the switch S2 of Leg1 and the switch S3 of Leg2 to be on, determining mode 3 in which the output voltage Vo is negative and the output current Io converges to 0;
by controlling the switch S2 of Leg1 and the switch S3 of Leg2 to be on, determining mode 4 in which the output voltage Vo is negative and the output current Io increases at a cathode (−);
by controlling the switch S2 of Leg1 to be off and the switch S1 of Leg1 and the switch S3 of Leg2 to be on, determining mode 5 in which the output voltage Vo is 0 and the output current Io decreases at the cathode (−);
by controlling the switch S3 of Leg2 to be off and the switch S1 of Leg1 and the switch S4 of Leg2 to be on, determining mode 6 in which the output voltage Vo is positive and the output current Io converges to 0.

6. The power control method of claim 5, wherein
the limiting of the variation range of the switching frequency comprises, due to the output voltage Vo being 0 by mode 2 and mode 5, outputting output voltage lower than when operating the full-bridge induction heating inverter with the switching frequency of the same size in PFM to limit the variation range of the switching frequency.

7. The power control method of claim 1, further comprising:
in the low-power section, by adjusting a switching interval of the switching frequency using pulse density modulation (PDM), minimizing frequency variation of the full-bridge induction heating inverter and reducing noise and vibration.

8. The power control method of claim 7, wherein
the reducing of noise and vibration comprises, by varying a size of a phase shift angle ϕ1 at a beginning and an end of a section of switching in a PDM cycle and a size of a phase shift angle ϕ2 in a middle of the section, maintaining the output power and reducing noise and vibration.

9. A power control device of minimizing frequency variation of a full-bridge induction heating inverter, the power control device comprising:
a definition unit configured to, as a switching frequency for operating the full-bridge induction heating inverter increases, define a section of output power that is output from the full-bridge induction heating inverter to include at least a mid-power section and a low-power section; and
a processor configured to, in the mid-power section and the low-power section, limit a variation range of the switching frequency by controlling power of a switch in the full-bridge induction heating inverter using phase shift modulation (PSM).

10. The power control device of claim 9, wherein
the definition unit is further configured to:
as the switch in the full-bridge induction heating inverter is power-controlled using pulse frequency modulation (PFM) and the switching frequency increases,
define the section of the output power as a high-power section when the increasing switching frequency is greater than or equal to a resonant frequency of the full-bridge induction heating inverter and less than a set first frequency;
define the section of the output power as the mid-power section when the increasing switching frequency is greater than or equal to the first frequency and less than a set second size; and
define the section of the output power as the low-power section when the increasing switching frequency is greater than or equal to a second frequency.

11. The power control device of claim 9, wherein
the processor is further configured to, in the mid-power section and the low-power section, limit the variation range of the switching frequency by making a range of increasing the switching frequency when controlling power using the PSM relatively smaller than a range of increasing the switching frequency when controlling power using PFM, in order to output regulated power.

12. The power control device of claim 9, further comprising:
a circuit unit configured to arrange switches S1 and S2 in series at one end of a circuit of the full-bridge induction heating inverter, arrange switches S3 and S4 in series at the other end of the circuit, and connect the switches S1 and S2 and the switches S3 and S4 in parallel,
wherein the processor is further configured to, by adjusting a phase difference ϕ between Leg1 including the switches S1 and S2 and Leg2 including the switches S3 and S4, determine a plurality of modes for power control using the PSM.

13. The power control device of claim 12, wherein
the processor is further configured to:
by controlling the switch S1 of Leg1 and the switch S4 of Leg2 to be on, determine mode 1 in which output voltage Vo is positive and output current Io increases at an anode (+);
by controlling the switches S1 and S2 of Leg1 to be off and the switch S4 of Leg2 to be on, determine mode 2 in which the output voltage Vo is 0 and the output current Io decreases at the anode (+);
by controlling the switch S4 of Leg2 to be off and the switch S2 of Leg1 and the switch S3 of Leg2 to be on, determine mode 3 in which the output voltage Vo is negative and the output current Io converges to 0;
by controlling the switch S2 of Leg1 and the switch S3 of Leg2 to be on, determine mode 4 in which the output voltage Vo is negative and the output current Io increases at a cathode (−);
by controlling the switch S2 of Leg1 to be off and the switch S1 of Leg1 and the switch S3 of Leg2 to be on, determine mode 5 in which the output voltage Vo is 0 and the output current Io decreases at the cathode (−);
by controlling the switch S3 of Leg2 to be off and the switch S1 of Leg1 and the switch S4 of Leg2 to be on, determine mode 6 in which the output voltage Vo is positive and the output current Io converges to 0.

14. The power control device of claim 13, wherein
the processor is further configured to, due to the output voltage Vo being 0 by mode 2 and mode 5, output output voltage lower than when operating the full-bridge induction heating inverter with the switching frequency of the same size in PFM to limit the variation range of the switching frequency.

15. The power control device of claim 9, wherein
the processor is further configured to, in the low-power section, by adjusting a switching interval of the switching frequency using pulse density modulation (PDM), minimize frequency variation of the full-bridge induction heating inverter and reduce noise and vibration.

16. The power control device of claim 15, wherein
the processor is further configured to, by varying a size of a phase shift angle ϕ1 at a beginning and an end of a section of switching in a PDM cycle and a size of a phase shift angle ϕ2 in a middle of the section, maintain the output power and reduce noise and vibration.

17. A non-transitory computer-readable storage medium storing instructions that, when executed by a processor, cause the processor to perform the method of claim 1.
